(19) United States
(12) Patent Application Publication
(10) Pub. No.: US 2021/0187455 A1
(43) Pub. Date: Jun. 24, 2021

(54) KNEADING METHOD

(71) Applicant: CHUO UNIVERSITY, Hachioji-shi, Tokyo (JP)

(72) Inventors: Taro NAKAMURA, Bunkyo-ku, Tokyo (JP); Yasuyuki YAMADA, Bunkyo-ku, Tokyo (JP); Hiroto HABU, Chofu-shi, Tokyo (JP); Akihiro IWASAKI, Chofu-shi, Tokyo (JP)

(73) Assignee: CHUO UNIVERSITY, Hachioji-shi, Tokyo (JP)

(21) Appl. No.: 17/054,365

(22) PCT Filed: May 10, 2019
(86) PCT No.: PCT/JP2019/018773

§ 371 Date: Nov. 10, 2020

(30) Foreign Application Priority Data
May 21, 2018 (JP) 2018-097411

(51) Int. Cl. B01F 11/00; B01F 3/12; C06B 21/00; F04B 43/12

(52) U.S. Cl. CPC B01F 11/0045; B01F 3/1207; B01F 2215/0057; F04B 43/12; C06B 21/0008

(57) ABSTRACT

A kneading method for kneading a mixture by repetitively forming a compressed space that is formed by an expanding-contracting body of a segment in an open state and an expanding-contracting body of a segment in a closed state adjacent to the segment in the open state and filled with the mixture in a compressed state pressed by the expanding-contracting body, by changing a combination of an operation state of each of the plurality of segments.

### TECHNICAL FIELD

The present disclosure relates to a kneading method.

### BACKGROUND

As a kneading method for kneading a mixture, a method using a kneading apparatus that includes a plurality of continuously arranged segments is known. In such a kneading apparatus, each of the plurality of segments includes a cylindrical expanding-contracting body. Also, an operation state of each of the plurality of segments can be switched between a closed state in which the expanding-contracting body is deformed expanding inward to substantially seal an inner side thereof and an open state in which the expanding-contracting body is deformed outward from the closed state. A kneading method using a kneading apparatus configured as described above is described in, for example, PTL 1 set forth below.

### CITATION LIST

### Patent Literature

PTL 1: WO2018/056378

### SUMMARY

### Technical Problem

However, the PTL 1 does not disclose a particular method for effectively kneading a mixture.

An object of the present disclosure is to propose a kneading method capable of effectively kneading a mixture.

### Solution to Problem

A kneading method according to an aspect of the present disclosure is a kneading method for kneading a mixture using a kneading apparatus, wherein the kneading apparatus includes a plurality of segments continuously arranged,

each of the plurality of segments includes a cylindrical expanding-contracting body,

an operation state of each of the plurality of segments can be switched between a closed state in which the expanding-contracting body is deformed expanding inward to substantially seal an inner side of the expanding-contracting body and an open state in which the expanding-contracting body is deformed outward from the closed state, and

the mixture is kneaded by repetitively forming a compressed space that is formed at least by an expanding-contracting body of a segment in the open state and an expanding-contracting body of a segment in the closed state adjacent to the segment in the open state, substantially sealed, and filled with the mixture in a compressed state pressed by the expanding-contracting body, by changing a combination of the operation state of each of the plurality of segments.

According to one embodiment of the present disclosure, the kneading method repetitively forms the compressed space by shifting the compressed space together with at least a portion of the mixture between the plurality of segments.

According to one embodiment of the present disclosure, the kneading method repetitively forms the compressed space by reciprocating the compressed space together with at least a portion of the mixture between the plurality of segments.

According to one embodiment of the present disclosure, the kneading method forms the compressed space using at least one segment in the open state and segments in the closed state located on either side of the at least one segment.

According to one embodiment of the present disclosure, the kneading method forms the compressed space using at least one segment in the open state, a segment in the closed state adjacent to one end of the at least one segment, and a closing wall provided to another end of the at least one segment.

According to one embodiment of the present disclosure, the kneading apparatus includes two segments, and the closing wall is provided to either end of the two segments as a whole.

According to one embodiment of the present disclosure, an operation state of each of the plurality of segments is switched from the open state to the closed state by the supply of a working fluid to an outside of the expanding-contracting body, or from the closed state to the open state by the discharge of the working fluid from the outside of the expanding-contracting body.

According to one embodiment of the present disclosure, each of the plurality of segments is contracted in an axial direction of the expanding-contracting body by switching of the operation state from the open state to the closed state, and expanded in the axial direction by switching of the operation state from the closed state to the open state.

According to one embodiment of the present disclosure, the mixture is composed of a liquid and a solid that does not dissolve in the liquid.

According to one embodiment of the present disclosure, the solid is a powder.

According to one embodiment of the present disclosure, the mixture is an explosive.

### Advantageous Effect

The kneading method according to the present disclosure can effectively knead the mixture.

### BRIEF DESCRIPTION OF THE DRAWINGS

In the accompanying drawings:

FIG. 1 is a longitudinal cross-sectional view illustrating a kneading apparatus used by a kneading method according to a first embodiment of the present disclosure;

FIG. 2A is a longitudinal cross-sectional view illustrating one of a plurality of segments constituting the kneading apparatus illustrated in FIG. 1;

FIG. 2B is a perspective view illustrating an inner tube and a ring in the segment illustrated in FIG. 2A;

FIG. 2C is a transverse cross-sectional view taken along line AA of FIG. 2A;

FIG. 3A is a longitudinal cross-sectional view illustrating another example of one of the plurality of segments constituting the kneading apparatus illustrated in FIG. 1;

FIG. 3B is a transverse cross-sectional view taken along the line BB of FIG. 3A;

FIG. 3C is a perspective view of a segment illustrated in FIG. 3A;

FIG. 4A is a longitudinal cross-sectional view for explaining the gist of kneading by the kneading method according to the first embodiment of the present disclosure;

FIG. 4B is a longitudinal cross-sectional view illustrating a state in which a compressed space is advanced together with a portion of the mixture by one segment from the state illustrated in FIG. 4A;

FIG. 4C is a longitudinal cross-sectional view illustrating a state in which the compressed space is retracted together with a portion of the mixture by one segment from the state illustrated in FIG. 4B;

FIG. 5A is a longitudinal cross-sectional view for explaining the gist of kneading by a kneading method according to a second embodiment of the present disclosure;

FIG. 5B is a longitudinal cross-sectional view illustrating a state in which the compressed space is retracted together with a portion of the mixture by one segment from the state illustrated in FIG. 5A;

FIG. 6A is a longitudinal cross-sectional view for explaining the gist of kneading by a kneading method according to a third embodiment of the present disclosure;

FIG. 6B is a longitudinal cross-sectional view illustrating a state in which the compressed space is retracted together with a portion of the mixture by one segment from the state illustrated in FIG. 6A;

FIG. 7A is a longitudinal cross-sectional view for explaining the gist of kneading by a kneading method according to a fourth embodiment of the present disclosure;

FIG. 7B is a longitudinal cross-sectional view illustrating a state in which the compressed space is retracted together with a portion of the mixture by one segment from the state illustrated in FIG. 7A; and

FIG. 8 is a graph illustrating a burning rate characteristic of each sample obtained from a strand burner test according to an example of the present disclosure.

### DETAILED DESCRIPTION

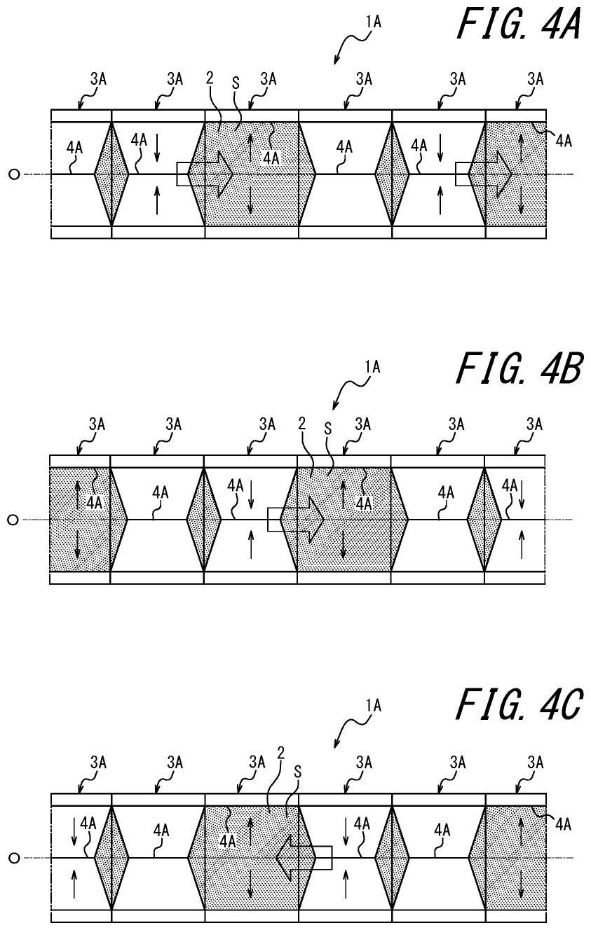

Hereinafter, a kneading method according to various embodiments of the present disclosure will be described in detail with reference to the drawings. For convenience of explanation, a shift from left to right in FIG. 4A to FIG. 7B will be referred to as forwarding, and a shift in an opposite direction will be referred to as retracting. Also, a left end in FIG. 4A to FIG. 7B will be referred to as one end, and a right end will be referred to as the other end. The respective thicknesses of an expanding-contracting body 4A and a flange 7 are omitted in FIG. 4A to 7B.

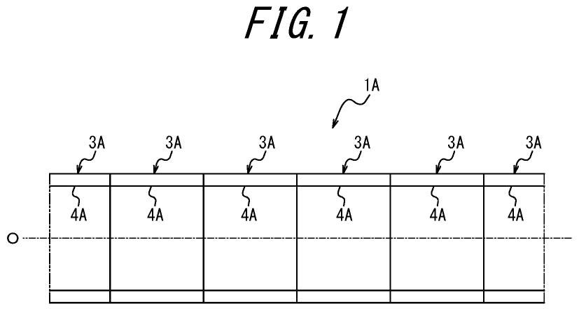

First, a kneading method according to a first embodiment of the present disclosure will be described in detail with reference to FIG. 1 to FIG. 4C. The kneading method according to the present embodiment is a method for kneading a mixture 2 using a kneading apparatus 1A (see FIG. 4A, etc.). In the present embodiment, the mixture 2 is composed of a liquid and a solid that does not dissolve in the liquid. In particular, the solid is a powder. The mixture 2 may be, for example, an explosive such as a rocket composite propellant. The mixture 2 as a composite propellant can be composed of, for example, a powder serving as an oxidizer, a powder serving as a metal fuel, and a liquid serving as a binder. Further, a plasticizer, a curing agent, or the like may be added in appropriate amounts. The mixture 2 may be cement, dough for noodle making, or the like, and is not limited thereto. The kneading method according to the present embodiment is suitable for kneading a solid-liquid mixture composed of a liquid and a solid that does not dissolve in the liquid. Further, the kneading method according to the present embodiment is particularly suitable for kneading a solid-liquid mixture such as an explosive, because the kneading apparatus used by the kneading method is unlikely to cause a false ignition source such as static electricity.

The kneading apparatus 1A includes a plurality of segments 3A that are continuously arranged, as illustrated in FIG. 1. Each of the plurality of segments 3A includes a cylindrical expanding-contracting body 4A. Also, an operation state of each of the plurality of segments 3A can be switched between a closed state in which an inner side of the expanding-contracting body 4A is substantially sealed due to an inward expanding deformation of the expanding-contracting body 4A and an open state in which the expanding-contracting body 4A is deformed outward from the closed state. The state in which the inner side of the expanding-contracting body 4A is “substantially closed” means that the inner side is closed to an extent that the mixture 2 is prevented from flowing through a closed portion. Further, the state in which the inner side of the expanding-contracting body 4A is “substantially sealed” means that a compressed space S, which will be described later, is closed to an extent that the mixture 2 is prevented from flowing through a sealed portion.

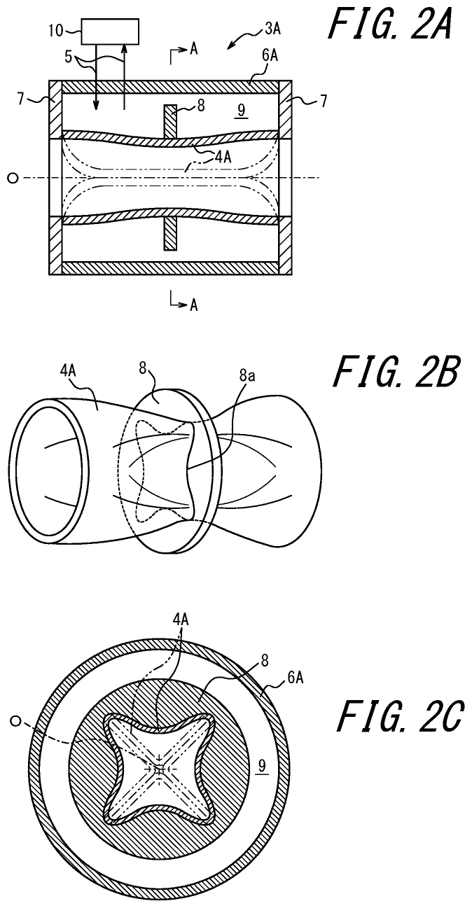

In the present embodiment, the plurality of segments 3A are configured such that an operation state of each of the plurality of segments 3A is switched from the open state to the closed state by the supply of a working fluid 5 (see FIG. 2A) to an outer side of the expanding-contracting body 4A, or from the closed state to the open state by the discharge of the working fluid 5 from the outer side of the expanding-contracting body 4A. The working fluid 5 may be, for example, a gas such as air or carbon dioxide, or a liquid such as water or oil.

In the present embodiment, each of the plurality of segments 3A has a configuration as illustrated in FIG. 2A to FIG. 2C. In the present embodiment, that is, each of the plurality of segments 3A includes the expanding-contracting body 4A, an external cylinder 6A that has a cylindrical shape arranged outside the expanding-contracting body 4A, flanges 7 having an annular plate-like shape arranged either axial end of the segment 3A, and a ring 8 attached to an outer surface of the expanding-contracting body 4A. In the present embodiment, each of the external cylinder 6A, the flange 7, and the ring 8 is formed from a rigid body. An axial direction of the segment 3A means a direction along a central axis 0 of the expanding-contracting body 4A (i.e., an axial direction of the expanding-contracting body 4A). Further, a cross-section including the central axis 0 of the expanding-contracting body 4A will be referred to as a longitudinal cross-section, and a cross-section orthogonal to the central axis 0 of the expanding-contracting body 4A will be referred to as a transverse cross-section.

Either axial end of the expandable member 4A is fixed to an inner peripheral edge of the flange 7 by an appropriate joining means in an airtight and liquid-tight manner. Either axial end of the external cylinder 6A is fixed to an outer peripheral edge of the flange 7 by an appropriate joining means in an airtight and liquid-tight manner. Thus, the expanding-contracting body 4A, the external cylinder 6A, and a pair of flanges 7 together define a chamber 9 for the working fluid 5.

A fluid supplying-discharging apparatus 10 included in the kneading apparatus 1A is connected to the chamber 9. The fluid supplying-discharging apparatus 10 can supply the working fluid 5 to the chamber 9. Also, the fluid supplying-discharging apparatus 10 can discharge the working fluid 5 from the chamber 9. The supplying-discharging apparatus 10 can control the supply and discharge of the working fluid 5 with respect to the chamber 9 of each of the plurality of segment 4A. The fluid supplying-discharging apparatus 10 may collectively supply or discharge the working fluid 5 with respect to some of the plurality of segments 3A. The fluid supplying-discharging apparatus 10 can be, for example, an air compressor, a pressure reducing valve, an ON/OFF valve, a processor (a microcomputer, etc.), or the like.

The ring 8 has an opening 8a having a star-like shape into which the expanding-contracting body 4A is inserted, as illustrated in FIG. 2B. The expanding-contracting body 4A has a cylindrical shape and is formed from an elastic body such as rubber or elastomer. When the expanding-contracting body 4A is inserted into the opening 8a of the ring 8, the expanding-contracting body 4A has a longitudinal cross-section having a star-like shape at the portion in contact with a peripheral portion of the opening 8a of the ring 8. As a result, when the working fluid 5 is supplied to the chamber 9, the expanding-contracting body 4A can be stably deformed expanding inward from the four directions in the cross-section, as indicated by the chain double-dashed lines in FIG. 2C. Thus, the expanding-contracting body 4A can switch the operation state from the open state to the closed state at least when the mixture 2 is not present in the expanding-contracting body 4A. The shape of the opening 8a of the ring 8 is not limited to the star-like shape and may be a non-circular shape including, for example, a triangular shape. In this case also, when the working fluid 5 is supplied to the chamber 9, the expanding-contracting body 4A can be stably deformed expanding inward from directions corresponding to the shape of the opening 8a in the longitudinal cross-section. Further, the ring 8 can be omitted. In this case, the expanding-contracting body 4A may be formed in a cylindrical shape or a tubular shape other than the cylindrical shape. When the expanding-contracting body 4A is formed in a cylindrical shape, for example, grooves extending in the axial direction may be formed at a plurality of circumferential locations, such that the cross-sectional shape of the expanding-contracting body 4A is stabilized at the time of inward expanding deformation. In this case also, the expanding-contracting body 4A can switch the operation state from the open state to the closed state, at least when the mixture 2 is not present in the expanding-contracting body 4A.

In the plurality of segments 3A, the flanges 7 of the segments 3A adjacent to each other are fixed to each other by an appropriate joining means in an airtight and liquid-tight manner. Thus, an inner space extending over the entire longitudinal length of the plurality of segments 3A is formed within the expanding-contracting bodies 4A of the plurality of segments 3A when all of these segments 3A are in the open state. In the present embodiment, the inner space is open to the outside at either longitudinal end of the plurality of segments 3A as a whole. Thus, the mixture 2 can be introduced from one end of the inner space, kneaded while being conveyed toward the other end of the inner space, and then taken out from the other end of the inner space. According to the kneading apparatus 1A of the present embodiment, as described above, the kneading and conveying of the mixture 2 can be realized simultaneously.

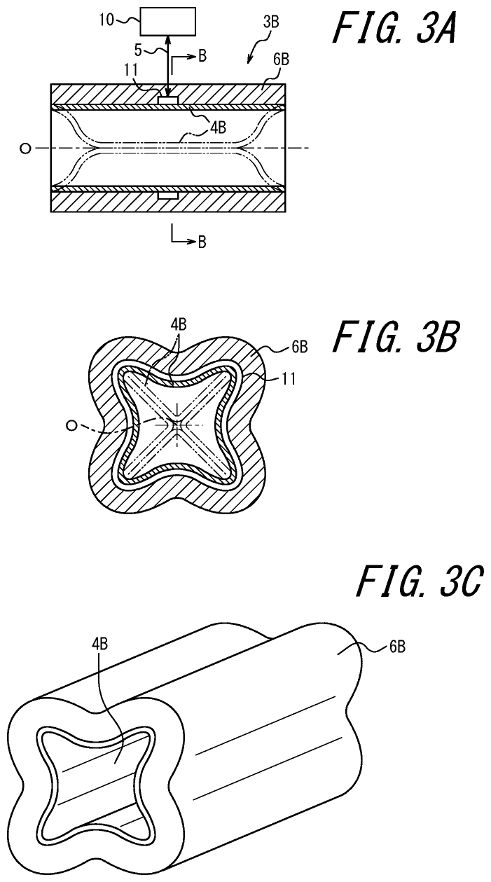

The segment 3A is not limited to have the configuration illustrated in FIG. 2A to FIG. 2C and may have, for example, a configuration illustrated in FIG. 3A to FIG. 3C. A segment 3B illustrated in FIG. 3A to FIG. 3C includes an expanding-contracting body 4B and a cylindrical external cylinder 6B arranged on the outer side of the expanding-contracting body 4B. The external cylinder 6B is formed from a rigid body in the present embodiment. Either axial end of the expanding-contracting body 4B is fixed to the external cylinder 6B by an appropriate joining means in an airtight and liquid-tight manner. A circumferential groove 11 is provided continuously over the entire circumference on the inner surface of the external cylinder 6B. The circumferential groove 11 is connected to the fluid supplying-discharging apparatus 10. The fluid supplying-discharging apparatus 10 can supply the working fluid 5 between the outer surface of the expanding-contracting body 4B and the inner surface of the external cylinder 6B via the circumferential groove 11. Also, the fluid supplying-discharging apparatus 10 can discharge the working fluid 5 from between the outer surface of the expanding-contracting body 4B and the inner surface of the external cylinder 6B via the circumferential groove 11. The fluid supplying-discharging apparatus 10 can control the supply and discharge of the working fluid 5 with respect to the plurality of segments 3B. The fluid supplying-discharging apparatus 10 may collectively control the supply and discharge of the working fluid 5 with respect to some of the plurality of segments 3B. Further, the circumferential groove 11 can be omitted and the working fluid 5 may be directly supplied to and discharged from between the outer surface of the expanding-contracting body 4B and the inner surface of the external cylinder 6B.

The external cylinder 6B has a transverse cross-section having a star-like shape over the axial direction. The expanding-contracting body 4B is formed from an elastic body such as rubber or elastomer in a cylindrical shape. By fixing or contacting the outer surface of the expandable member 4B to the inner surface of the external cylinder 6B having the star-like shape, the expanding-contracting body 4B has the transverse cross-section having the star-like shape over the axial direction. As a result, the expanding-contracting body 4B can be deformed expanding inward from four directions in the transverse cross-section when the working fluid 5 is supplied to the circumferential groove 11, as indicated by the chain double-dashed lines illustrated in FIG. 3B. The transverse cross-sectional shape of the external cylinder 6B is not limited to the star-like shape and may be a non-circular shape including, for example, a triangular shape or a circular shape. Further, the expanding-contracting body 4B may be formed in a tubular shape other than the cylindrical shape.

In the plurality of segments 3B, the external cylinders 6B and the expanding-contracting bodies 4B of the segments 3B adjacent to each other are fixed to each other by an appropriate joining means in an airtight and liquid-tight manner. Thus, an inner space extending along the longitudinal direction throughout the plurality of segments 3B is formed within the expanding-contracting bodies 4B of all the plurality of segments 3B when all the segments 3B are in the open state. The external cylinders 6B and/or the expanding-contracting bodies 4B of the segments 3B adjacent to each other may be integrally formed.

In the present embodiment, the mixture 2 is kneaded by the kneading apparatus 1A as described above that changes a combination of an operation state of each of the plurality of segments 3A by repetitively forming the compressed space S (see FIG. 4A) that is formed by at least the expanding-contracting body 4A of the segment 3A in the open state and the expanding-contracting body 4A of the segment 3A in the closed state adjacent to the segment 3A (in particular, at least one segment 3A in the open state and the closed segment 3A located on either side of the at least one segment 3A), substantially sealed, and filled with the mixture 2 in the compressed state compressed by the expanding-contracting body 4A.

That is, in the kneading method according to the present embodiment, an introducing amount of the mixture 2 (i.e., a ratio of the volume of the mixture 2 to the volume of the inner space) to be introduced into the inner space extending in the longitudinal direction throughout the plurality of segments 3A can be adjusted to form the compressed space S that is substantially sealed and filled with the mixture 2 in the compressed state compressed by the expanding-contracting body 4A. In introducing the mixture 2 into the inner space, for example, the liquid component and the powder component may be separately introduced; a slurry obtained by pre-kneading the liquid component and the powder component using any kneading apparatus may be introduced; a slurry and the liquid component may be separately introduced; a slurry and the powder component may be separately introduced; or a slurry of a predetermined component and a slurry of another component may be separately introduced.

In the kneading method according to the present embodiment, the compressed space S is repetitively formed by shifting the compressed space S together with at least a portion of the mixture 2 between the plurality of segments 3A. That is, the kneading method according to the present embodiment includes a step of changing a combination of the operation state of each of the plurality of segments 3A, in a manner such that the compressed state S is shifted together with at least a portion of the mixture 2 between the plurality of segments 3A, as illustrated in FIG. 4B. This step can be performed by, for example, setting one of the segments 3A in the open state to the closed state and, simultaneously, setting the segment 3A that is in the closed state and located at the other end of the segment 3A in the open state to the open state, as illustrated in FIG. 4A and FIG. 4B. That is, the expanding-contracting body 4A in the open state including the compressed space S of the segment 3A on one side is deformed to expand inward and press the mixture 2 and, simultaneously, the expanding-contracting body 4A in the segment 3A in the closed state on the other side is deformed outward, whereby the mixture 2 is pushed and flows from one side to the other side. In a state in which a space surrounded by the expanding-contracting body 4A is formed in the segment 3A on the other side, this space is filled with the mixture 2 in the compressed state.

Further, the kneading method according to the present embodiment includes a step of changing a combination of an operation state of each of the plurality of segments 3A, such that the compressed space S is shifted together with at least a portion of the mixture 2 from one end of the longitudinal direction of the plurality of segments 3A as a whole to the other end.

According to the present embodiment, the compressed space S (see FIG. 4A) that is substantially sealed and filled with the mixture 2 in the compressed state is formed at least by the expanding-contracting body 4A of the segment 3A in the open state and the expanding-contracting body 4A of the segment 3A in the closed state adjacent to the segment 3A in the open state, whereby both the kneading effect by the flow of the mixture 2 and the kneading effect by the compression of the mixture 2 can be simultaneously obtained. Kneading the mixture 2 not only by flowing but also by compressing enables effective permeation of the liquid constituting the mixture 2 into a dry portion of the solid (the powder) constituting the mixture 2. According to the kneading method of the present embodiment, thus, even if the mixture 2 has a high proportion of a powder with respect to the liquid, the liquid can be formed into a homogeneous plastic or slurry encapsulating powder particles by the kneading combining the flow and compression of the mixture 2. According to the kneading method of the present embodiment, further, a shearing force applied to the mixture 2 can be reduced as compared with, for example, a kneading method using a planetary mixer, and thus powder breaking during the kneading is suppressed. This enables stable obtainment of the properties of the mixture 2 that should be expressed by kneading.

According to the kneading method of the present embodiment, by shifting the compressed space S together with at least a portion of the mixture 2 between the plurality of segments 3A, the kneading effect by the flow of the mixture 2 described above can be improved.

According to the kneading method of the present embodiment, by shifting the compressed space S together with at least a portion of the mixture 2 from one end of the longitudinal direction of the plurality of segments 3A as a whole to the other end, the kneading and the conveying of the mixture 2 can be simultaneously performed.

In the kneading method according to the present embodiment, the compressed space S may be repetitively formed by reciprocating the compressed space S together with at least a portion of the mixture 2 between the plurality of segments 3A. That is, the kneading method according to the present embodiment may include a step of changing a combination of an operation state of each of the plurality of segments 3A, such that the compressed space S is reciprocated together with at least a portion of the mixture 2 between the plurality of segments 3A, as illustrated in FIG. 4C. This step can promote the flow of the mixture 2 by a pendulum shift and thus can improve the kneading effect by the flow of the mixture 2.

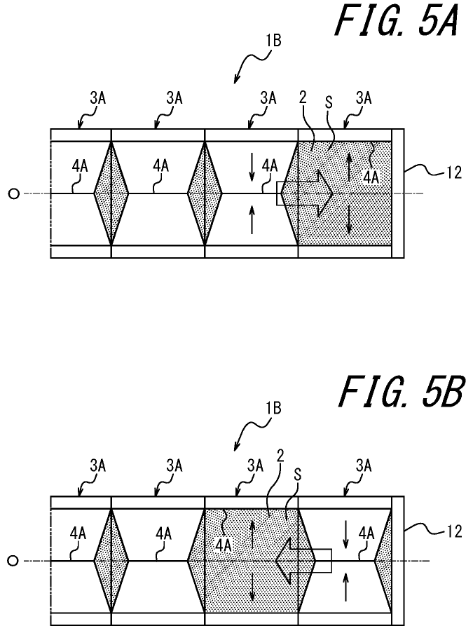

Next, a kneading method according to a second embodiment of the present disclosure will be described in detail with reference to FIG. 5A and FIG. 5B. A kneading apparatus 1B used in the present embodiment has the same configuration as the kneading apparatus 1A used in the first embodiment, except for that a closing wall 12 is provided to the other end of the longitudinal direction of the plurality of segments 3A as a whole.

In the present embodiment, the kneading apparatus 1B includes a plurality of segments 3A that are continuously arranged, as illustrated in FIG. 5A and FIG. 5B. A closing wall 12 having a disc-like shape is fixed to the other end of the longitudinal direction of the plurality of segments 3A as a whole by an appropriate joining means in an airtight and liquid-tight manner. Thus, an inner space formed within the expanding-contracting members 4A of the plurality of segments 3A as a whole is closed by the closing wall 12 at the other end of the longitudinal direction. According to the kneading apparatus 1B configured as described above, the mixture 2 can be introduced from one end of the inner space, kneaded while being shifted in the inner space, and then taken out from the one end of the inner space after the kneading. The configuration of the segments 3A can be modified in various ways, in a manner similar to the first embodiment.

In a kneading method according to the present embodiment using the kneading apparatus 1B configured as described above, the compressed space S is formed at least by the expanding-contracting body 4A of the segment 3A in the open state and the expanding-contracting body 4A of the segment 3A in the closed state adjacent to the segment 3A in the open state (in particular, by at least one segment 3A in the open state, the segment 3A in the closed state adjacent to one end of the at least one segment 3A, and the closing wall 12 provided to the other end of the at least one segment 3A), as illustrated in FIG. 5A.

The kneading method according to the present embodiment includes a step of changing a combination of an operation state of each of a plurality of segments 3A, such that the compressed space S is shifted together with at least a portion of the mixture 2 from one end of the longitudinal direction of the plurality of segments 3A as a whole to the other end and then shifted from the other end to the one end, as illustrated in FIG. 5B.

According to the kneading method of the present embodiment, the kneading effect by the flow of the mixture 2 and the kneading effect by the compression of the mixture 2 can be simultaneously obtained, in a manner similar to the first embodiment.

The kneading method according to the present embodiment may include a step of changing a combination of an operation state of each of a plurality of segments 3A, such that, when the compressed space S is shifted together with at least a portion of the mixture 2 from one end of the longitudinal direction of the plurality of segments 3A as a whole to the other end, the compressed space S is reciprocated together with at least a portion of the mixture 2 between the plurality of segments 3A. Further, the kneading method according to the present embodiment may include a step of changing a combination of an operation state of each of a plurality of segments 3A, such that, when the compressed space S is shifted together with at least a portion of the mixture 2 from the other end of the longitudinal direction of the plurality of segments 3A as a whole to the one end, the compressed space S is reciprocated together with at least a portion of the mixture 2 between the plurality of segments 3A.

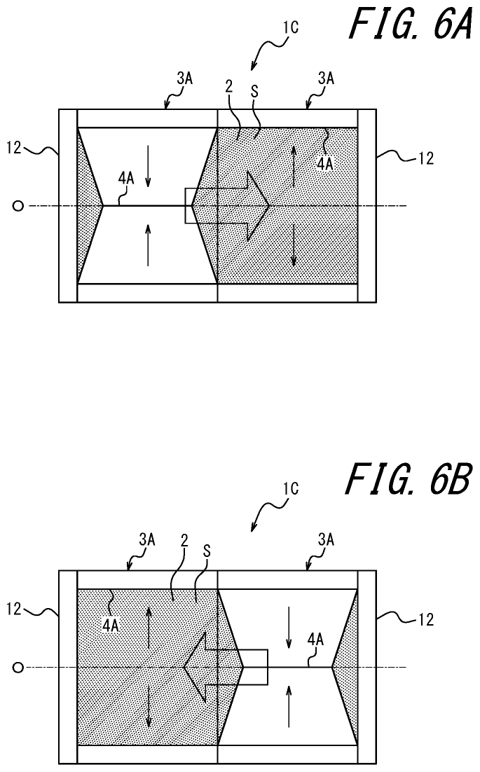

Next, a kneading method according to a third embodiment of the present disclosure will be described in detail with reference to FIG. 6A and FIG. 6B. A kneading apparatus 1C used in the present embodiment includes two segments 3A and has the same configuration as the kneading apparatus 1B used in the second embodiment, except for that the closing wall 12 is provided to either end of the two segments 3A as a whole.

In the present embodiment, the kneading apparatus 1C includes two segments 3A that are continuously arranged, as illustrated in FIG. 6A and FIG. 6B. A closing wall 12 having a disc-like shape is fixed to either end of a longitudinal direction of the two segments 3A by an appropriate joining means in an airtight and liquid-tight manner. Thus, an inner space formed within the extending-contracting body 4A of the two segments 3A is closed by the closing walls 12 at either ends of the longitudinal direction. In the present embodiment, an introduction path that can open and close to allow introduction of the mixture 2 into the inner space can be provided to one of the two closing walls 12, and a discharge path that can be open and close to allow discharge of the mixture 2 from the inner space can be provided to the other one of the two closing walls 12. Further, the introduction path and/or the discharge path configured as described above may be provided to, for example, the flange 7 illustrated in FIG. 2A. The introduction path and the discharge path may be controlled to open and close by an ON/OFF valve, a processor (a microcomputer, etc.), or the like. According to the kneading apparatus 1C configured as described above, the mixture 2 can be introduced into the inner space, kneaded while being shifted within the inner space, and then taken out from the inner space after the kneading. The configuration of the segment 3A can be modified in various ways, in a manner similar to the first embodiment.

As illustrated in FIG. 6A, the kneading method according to the present embodiment using the kneading apparatus 1C configured as described above includes the step of changing a combination of an operation state of each of a plurality of segments 3A, so as to alternately repeat a first step of forming the compressed space S by the segment 3A in the open state, the segment 3A in the closed state adjacent to one end of the segment 3A in the open state, and the closing wall 12 provided to the other end of the segment 3A in the open state as illustrated in FIG. 6A, and a second step of forming the compressed space S by the segment 3A in the open state, the segment 3A in the closed state adjacent to the other end of the segment 3A in the open state, and the closing wall 12 provided to one end of the segment 3A in the open state as illustrated in FIG. 6B.

According to the kneading method of the present embodiment, the kneading effect by the flow of the mixture 2 and the kneading effect by the compression of the mixture 2 can be simultaneously obtained, in a manner similar to the first embodiment. According to the kneading method of the present embodiment, further, the flow of the mixture 2 can be promoted by repeating the pendulum motion, whereby the kneading effect by the flow of the mixture 2 can be improved.

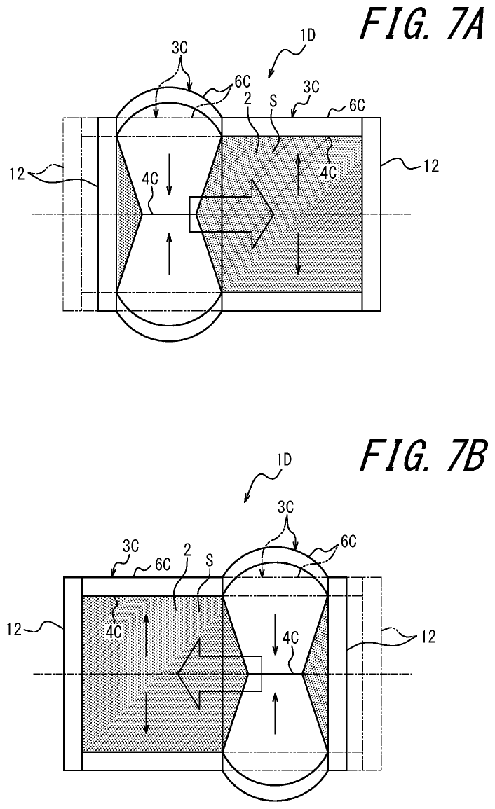

Next, a kneading method according to a fourth embodiment of the present disclosure will be described in detail with reference to FIG. 7A and FIG. 7B. A kneading apparatus 1D used in the present embodiment has a configuration similar to the kneading apparatus 1C used in the third embodiment, except for that a plurality of (two in the example of the drawing) segments 3C contract in the axial direction when their operation states are switched from the open state to the closed state and extend in the axial direction when their operation states are switched from the closed state to the open state.

In the present embodiment, the kneading apparatus 1D includes two segments 3C that are continuously arranged, as illustrated in FIG. 7A and FIG. 7B. A closing wall 12 having a disc-like shape is fixed to either end of the entire longitudinal direction of the two segments 3C by an appropriate joining means in an airtight and liquid-tight manner. Thus, an inner space formed within the extending-contracting body 4C of the two segments 3C as a whole is closed by the closing wall 12 at either end of the longitudinal direction. The configuration of the segment 3C can be modified in various ways, in a manner similar to the first embodiment.

In the present embodiment, each of the two segments 3C includes an external cylinder 6C formed by an axially fiber-reinforced type elastic cylindrical body in which a plurality of fiber cords extending in the axial direction are embedded and the expanding-contracting body 4C formed from an elastic cylindrical body in which fiber cords are not embedded, in a manner similar to the first to third embodiments. However, for example, both the external cylinder 6C and the expanding-contracting body 4C may be formed from the respective axially fiber-reinforced type elastic cylindrical bodies. This configuration enables each of the two segments 3C to contract in the axial direction when its operation state is switched from the open state to the closed state, and to expand in the axial direction when its operation state is switched from the closed state to the open state. The external cylinder 6C may be formed from a sleeved fiber-reinforced type elastic cylindrical body, such as a so-called Macchiben type artificial muscle, in which the outer surface of the elastic cylindrical body is covered with a fiber cord woven into a sleeve shape, rather than the axially fiber-reinforced type elastic cylindrical body.

The kneading method according to the present embodiment using the kneading apparatus 1D as described above includes a step of changing a combination of an operation state of each of a plurality of segments 3C to alternately repeat a first step in which the compressed space S is formed by the segment 3C in the open state, the segment 3C in the closed state that is adjacent to one end of the segment 3C in the open state, and the closing wall 12 provided to the other end of the segment 3C in the open state as illustrated in FIG. 7A and a second step in which the compressed space S is formed by the segment 3C in the open state, the segment 3C in the closed state adjacent to the other end of the segment 3C in the open state, and the closing wall 12 provided to one end of the segment 3C in the open state as illustrated in FIG. 7B.

According to the kneading method of the present embodiment, the kneading effect by the flow of the mixture 2 and the kneading effect by the compression of the mixture 2 can be simultaneously obtained, in a manner similar to the first embodiment. According to the kneading method of the present embodiment, also, the flow of the mixture 2 can be promoted by repeating the pendulum motion, and thus the kneading effect of the flow of the mixture 2 can be improved. According to the kneading method of the present embodiment, further, when the segment 3C in the open state is switched to the closed state, the expanding-contracting body 4C of the segment 3C is deformed expanding inward while contracting in the axial direction, whereby the mixture 2 can be strongly pushed in the axial direction. Thus, the flow of the mixture 2 can be promoted, and the kneading effect can be improved.

Note that, also in the first to third embodiments described above, all or some of the plurality of segments 3A may be contracted in the axial direction by switching operation states from the open state to the closed state and expanded in the axial direction by switching their operation states from the closed state to the open state, in a manner similar to the present embodiment.

The descriptions presented above merely illustrate examples of the embodiments of the present disclosure, and various modifications can be made without departing from the gist of the disclosure.

For example, an air discharge path for discharging, to the outside of the kneading apparatus, a slight amount of air that gradually escapes to the outside of the mixture from fine gaps between the powders along with the progress of the kneading of the mixture 2 may be provided to the closing wall and/or the flange or the like, in the first to fourth embodiments.

### EXAMPLE

A kneading apparatus having the same configuration as the kneading apparatus 1D used in the fourth embodiment described above was manufactured as an example of the present disclosure. A composite propellant was kneaded by the kneading apparatus, and the performance of the composite propellant after the kneading was evaluated.

A rocket composite propellant was used as the mixture to be kneaded. The rocket composite contained AP powder (ammonium perchlorate) serving as an oxidizer, Al powder (aluminium) serving as a metal fuel, HTPB (Hydroxyl Terminated Polybutadiene) serving as a liquid binder, DOA (dioctyl adipate) serving as a liquid plasticizer, and IPDI (isophorone diisocyanate) serving as a liquid hardener. The compounding ratio (a mass ratio) was set to AP:Al:HTPB:DOA:IPDI=68:18:12:1:1. A mixture having a particle size of 400 μm, 200 μm, or 50 μm manufactured by Nippon Carlit Co., Ltd. was used as the AP powder. TFH-A05P (a median diameter of 5 μm) manufactured by TOYO ALUMINUM K.K. was used as the Al powder. P-41 manufactured by JSR Corporation was used as the HTPB. The Al powder, HTPB, DOA, and IPDI were pre-kneaded using a planetary mixer before mixing the AP powder.

In the manufactured kneading apparatus, an expanding-contracting body had an axial length of 90 mm and an inner diameter of φ60 mm. A ring-shaped disc (thickness: 10 mm) made of acrylic resin having an introduction port for a pre-kneaded slurry and an AP powder was placed between two segments. Hot water at 80° C. was poured onto a flange (thickness: 10 mm) of the segment to heat the inner side thereof. To the kneading apparatus, compressed air was supplied to the outside of the expanding-contracting body from a supply port via a regulator and a solenoid valve.

Operation states of the two segments were simultaneously switched (that is, the working fluid was supplied to one segment and, simultaneously, discharged from the other segment) at operating intervals of 2 seconds. A pressure of the compressed air was at 60 kPa. Then, to find an optimum amount (an introducing amount) of the mixture with respect to the volume of the inner space of the kneading apparatus to obtain the kneading effect, three levels were set from 500 g in 50 g increments, using the introducing amount as a parameter. For any of the three introducing amounts (500 g, 550 g, 600 g), first, the pre-kneading slurry was put into the kneading apparatus, and the kneading apparatus was operated for 5 minutes to disperse the pre-kneading slurry within the apparatus. Next, the AP powder was added, and the apparatus was operated for a set kneading time (30 minutes, 40 minutes, 60 minutes, or 80 minutes). A propellant slurry thus obtained was casted and defoamed under a reduced pressure for approximately 1 hour, and then left to cure in a thermostatic chamber at an atmospheric pressure of 60° C. for 1 week.

A strand combustion test was conducted after the inner side of the cured propellant was confirmed by performing an X-ray nondestructive inspection. In the strand combustion test, the cured propellant was cut into a prism shape of 7 mm×7 mm×40 mm, the surface of which was subjected to a restrictor treatment using an epoxy resin, and the propellant was then burned under a nitrogen gas pressure. A burning rate of the central area in 20 mm of the propellant was calculated from an image analysis.

The propellant samples obtained by kneading for 60 minutes were compared to one another using the introducing amount of the sample as a parameter. It was confirmed by the X-ray transmission image that a plurality of voids were present in the propellant sample in the introducing amount of 500 g. There is a possibility that the kneading was insufficient. Insufficient mixing after kneading was visually recognized for the sample propellant in the introducing amount of 600 g. Further, a strand combustion test was conducted in a range of 3 to 7 MPa using 9 samples for each introducing amount. Table 1 shows a pressure index n of a sample burning rate and the correlation coefficient R² for each introducing amount used as a parameter. It was confirmed that there was no problem in the pressure index n and the correlation coefficient R² in the introducing amount of 550 g. From these results, it can be determined that the introducing amount of 550 g is suitable on the scale of the present apparatus and the introducing amounts of 500 g and 600 g are unsuitable. In the apparatus used in the experiment, it was confirmed by calculation that, when the introducing amount exceeds approximately 540 g, “compressed space filled with the mixture which is substantially blocked and compressed due to the pressure by the expanding-contracting body” is formed, which is consistent with the above experimental results. It is speculated that, when the introducing amount was 500 g, the closed space formed when a segment in the open state is switched to the closed state is not filled with the mixture and thus the compressing effect by the mixture due to the pressure by the expanding-contracting body was not sufficiently obtained because of air intervening between the expanding-contracting body and the mixture. It is also speculated that, when the introducing amount was 600 g, a segment in the open state could not be switched to the closed state, and thus the flow of the mixture was insufficient.

TABLE 1

| Introducing Amount (g) | Pressure Index n | Correlation Coefficient R² |
|---|---|---|
| 500 | 0.54 | 0.74 |
| 550 | 0.44 | 0.98 |
| 600 | 0.51 | 0.97 |

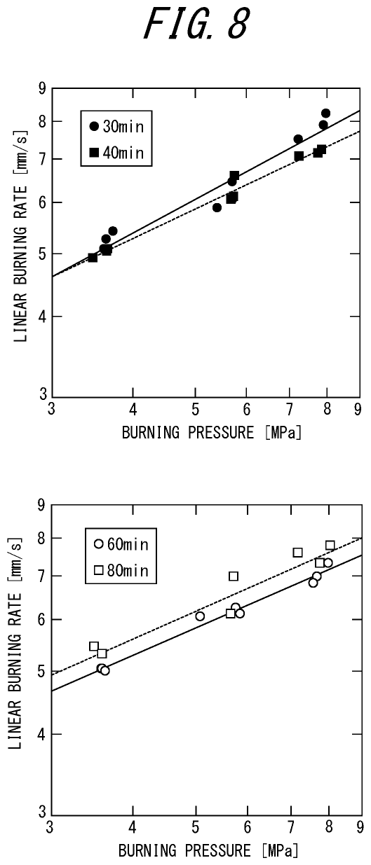

Next, when the introducing amount was 550 g and the kneading time was used as a parameter, a plurality of voids were observed in an X-ray transmission image of the sample obtained by the kneading time of 30 minutes. Also, it was confirmed that hardening was already progressed after the kneading and a fluidity of the slurry decreased in the sample obtained by the kneading time of 80 minutes. FIG. 8 illustrates a burning rate characteristic of each sample obtained from the strand burning test. In FIG. 8, the solid lines respectively represent approximate straight lines of 30 minutes and 60 minutes, the broken lines respectively represent approximate straight lines of 40 minutes and 80 minutes. Table 2 shows the correlation coefficient R² of the approximate straight line of each sample and a converted burning rate at 5 MPa. Both the correlation coefficient R² for the kneading time of 40 minutes and that for the kneading time of 60 minutes were close to each other, and the converted burning rate for the kneading time of 40 minutes and that for the kneading time of 60 minutes were close to each other, and thus the samples were kneaded sufficiently.

TABLE 2

| Kneading Time | Correlation | Converted Burning |
|---|---|---|
| (min) | Coefficient R² | Rate |
| 30 | 0.94 | 6.07 |
| 40 | 0.98 | 5.86 |
| 60 | 0.98 | 5.83 |
| 80 | 0.91 | 6.18 |

The propellant was kneaded under a usage condition (i.e., introducing amount: 550 g, kneading time: 40 minutes) of the kneading apparatus extracted as described above, and solid rocket motor grains of φ80 mm were produced as a prototype. In the combustion test, it was confirmed that the grains were burnt at an average internal pressure of 5.48 MPa.

### REFERENCE SIGNS LIST

1A, 1B, 1C, 1D kneading apparatus

2 mixture

3A, 3B, 3C segment

4A, 4B, 4C expanding-contracting body

5 working fluid

6A, 6B, 6C external cylinder

7 flange

8 ring

8a opening

9 chamber

10 fluid supplying-draining apparatus

11 circumferential groove

12 closing wall

O central axis

S compressed space

1. A kneading method for kneading a mixture using a kneading apparatus,
wherein the kneading apparatus includes a plurality of segments that are continuously arranged,
each of the plurality of segments has a cylindrical expanding-contracting body,
an operation state of each of the plurality of segments can be switched between a closed state in which the expanding-contracting body is deformed expanding inward to substantially seal an inner side of the expanding-contracting body and an open state in which the expanding-contracting body is deformed outward from the closed state, and
the mixture is kneaded by repetitively forming a compressed space that is formed at least by an expanding-contracting body of a segment in the open state and an expanding-contracting body of a segment in the closed state adjacent to the segment in the open state, substantially sealed, and filled with the mixture in a compressed state pressed by the expanding-contracting body, by changing a combination of the operation state of each of the plurality of segments.

2. The kneading method according to claim 1,
wherein the compressed space is repetitively formed by shifting the compressed space together with at least a portion of the mixture between the plurality of segments.

3. The kneading method according to claim 1,
wherein the compressed space is repetitively formed by reciprocating the compressed space together with at least a portion of the mixture between the plurality of segments.

4. The kneading method according to claim 1,
wherein the compressed space is formed by at least one segment in the open state and segments in the closed state located on either side of the at least one segment.

5. The kneading method according to claim 1,
wherein the compressed space is formed by at least one segment in the open state, a segment in the closed state adjacent to one end of the at least one segment, and a closing wall provided to another end of the at least one segment.

6. The kneading method according to claim 5,
wherein the kneading apparatus includes two segments, and
the closing wall is provided to either end of the two segments as a whole.

7. The kneading method according to claim 1,
wherein an operation state of each of the plurality of segments is switched from the open state to the closed state by supply of a working fluid to an outside of the expanding-contracting body, and from the closed state to the open state by discharge of the working fluid from the outside of the expanding-contracting body.

8. The kneading method according to claim 1,
wherein each of the plurality of segments is contracted in an axial direction of the expanding-contracting body by switching of the operation state from the open state to the closed state, and expanded in the axial direction by switching of the operation state from the closed state to the open state.

9. The kneading method according to claim 1,
wherein the mixture is composed of a liquid and a solid that does not dissolve in the liquid.

10. The kneading method according to claim 9,
wherein the solid is a powder.

11. The kneading method according to claim 1,
wherein the mixture is an explosive.
